(19) United States
(12) Patent Application Publication
(10) Pub. No.: US 2023/0004974 A1
(43) Pub. Date: Jan. 5, 2023

(54) PLAN INTERACTION UTILIZING CRYPTOGRAM

(71) Applicant: Visa International Service Association, San Francisco, CA (US)

(72) Inventors: Amy Poon, Pleasanton, CA (US); Anuja Seton, San Francisco, CA (US); Phillip Lavender, Foster City, CA (US); Xiaodong Jiang, San Carlos, CA (US); Shivam Tickoo, San Francisco, CA (US); Thomas Bellenger, Pacifica, CA (US); Udit Batra, Fremont, CA (US)

(21) Appl. No.: 17/784,981

(22) PCT Filed: Dec. 14, 2020
(86) PCT No.: PCT/US2020/064935

§ 371 Date: Jun. 13, 2022

Related U.S. Application Data
(60) Provisional application No. 62/948,073, filed on Dec. 13, 2019.

(51) Int. Cl. G06Q 20/40; H04L 9/40

(52) U.S. Cl. CPC G06Q 20/4014; H04L 63/083; H04L 63/0892

(57) ABSTRACT

A method includes a network processing computer receiving an authorization request message comprising a token and a cryptogram during an interaction between a resource provider and a user. The network processing computer determines user credentials associated with the token. The network processing computer then determines a plan identifier based on the authorization request message. The network processing computer provides the plan identified to an authorizing entity computer.

### CROSS REFERENCE TO RELATED APPLICATIONS

This application claims the benefit of the filing date of U.S. Provisional Application No. 62/948,073, filed on Dec. 13, 2019, and is incorporated by reference herein in its entirety for all purposes.

### BACKGROUND

Plans are an option for resolving interactions such as payment for goods or services. For example, during a plan, payments may be spread out over fixed intervals. A plan may be offered by a resource provider to a user. In other use cases, other entities may offer plans to a user.

During an interaction, if a plan is to be selected and implemented, then additional messaging is required to pass plan information between computers in the interaction system. Additionally, a user may typically be notified of available plans after a resource provider computer submits interaction data for authorization. For example, a network processing computer may receive an authorization request message including the interaction data for authorization of the interaction from the resource provider computer. The network processing computer can then reach out to the user to query the user on whether or not the user wants to select a plan, thus slowing down the processing of the interaction due to messaging and waiting for user input.

Embodiments of the disclosure address this problem and other problems individually and collectively.

### SUMMARY

One embodiment is related to a method comprising: receiving, by a network processing computer, an authorization request message comprising a token and a cryptogram during an interaction between a resource provider and a user; determining, by the network processing computer, user credentials associated with the token; determining, by the network processing computer, a plan identifier based on the authorization request message; and providing, by the network processing computer, and the plan identifier or plan information associated with the plan identifier to an authorizing entity computer. The authorizing entity computer can determine whether or not to authorize the interaction.

Another embodiment is related to a network processing computer comprising: a processor; and a computer readable medium coupled to the processor, the computer readable medium comprising code, executable by the processor, for implementing a method comprising: receiving an authorization request message comprising a token and a cryptogram during an interaction between a resource provider and a user; determining user credentials associated with the token; determining a plan identifier based on the authorization request message; and providing the plan identifier or plan information associated with the plan identifier to an authorizing entity computer. The authorizing entity computer can determine whether or not to authorize the interaction.

Another embodiment is related to a method comprising: receiving, by a user device, one or more plans from a service provider computer during an interaction between a user of the user device and a resource provider of a resource provider computer; receiving, by the user device, a selection of a plan of the one or more plans from the user; determining, by the user device, a plan identifier based on the selected plan; obtaining, by the user device, a token; and providing, by the user device, the plan identifier and the token to the resource provider computer.

Further details regarding embodiments of the disclosure can be found in the Detailed Description and the Figures.

### BRIEF DESCRIPTION OF THE DRAWINGS

FIG. 1 shows a block diagram of an installment processing system according to embodiments.

FIG. 2 shows a block diagram of components of a network processing computer according to embodiments.

FIG. 3 shows a flow diagram of a pre-interaction setup process according to embodiments.

FIG. 4 shows a block diagram of a user plan interface according to embodiments.

FIG. 5 shows a flow diagram of a plan and interaction processing method according to embodiments.

FIG. 6 shows a flow diagram of an alternate plan and interaction processing method according to embodiments.

FIGS. 7A-7B show block diagrams of a user interface during interaction processing according to embodiments.

FIG. 8 illustrates a schematic diagram of post-interaction installment processing according to some embodiments.

### DETAILED DESCRIPTION

Prior to discussing embodiments of the disclosure, some terms can be described in further detail.

A “user” may include an individual or a machine that operates something. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “credential” may comprise any evidence of authority, rights, or entitlement to privileges. For example, access credentials may comprise permissions to access certain tangible or intangible assets, such as a building or a file. In another example, payment credentials may include any suitable information associated with and/or identifying an account (e.g., a payment account and/or a payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCW (dynamic card verification value), a CVV2 (card verification value 2), a CVC3 (card verification code 3), etc. An example of a PAN is a 16-digit number, such as “4147 0900 0000 1234”. In some embodiments, credentials may be considered sensitive information. Credentials associated with a user can be “user credentials.”

A “token” may be a substitute value for a credential. A token may be a string of numbers, letters, or any other suitable characters. Examples of tokens include payment tokens, access tokens, personal identification tokens, etc. A payment token may include an identifier for an account that is a substitute for account data, such as an account number. For example, a token may include a series of alphanumeric characters that may be used as a substitute for an original account identifier. For example, a token “4900 0000 0000 0001” may be used in place of a PAN “4147 0000 1234.” In some embodiments, a token may be “format preserving” and may have a numeric format that conforms to the account identifiers used in existing transaction processing network computers. In some embodiments, a token may be used in place of an account number to initiate, authorize, settle or resolve a transaction or represent the original credential in other systems where the original credential would typically be provided. In some embodiments, a token value may be generated such that the recovery of the original account number or other account identifier from the token value may not be computationally derived. Further, in some embodiments, the token format may be configured to allow the entity receiving the token to identify it as a token and recognize the entity that issued the token.

An “interaction” can be a reciprocal action, effect, or influence. An interaction, for example, could be an exchange or transaction between two or more parties. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

An “Application Programming Interface” or “API” may include software specifying how components of a system should interact. The API may comprise a set of routines, protocols, and tools on which software applications may be built. An API may be used for a web-based system, operating system, database system, computer hardware or software library, and may include specifications for routines, data structures, object classes, variables and/or remote calls.

A “plan” can include a proposal for doing or achieving something. A plan can include one or more actions, events, or methods that can be proposed to occur in the future. A plan can include an intention to perform the actions, events, or methods. A plan can include any suitable type of plan, for example, an installment plan (e.g., a payment plan), a data plan, a digital or physical asset transfer plan, and/or any other actions, events, or methods that can be planned to do or achieve a goal. A plan can relate to an interaction. In some embodiments, a plan can alter an interaction in a particular predefined manner (e.g., an installment plan can separate a transaction total into a plurality of payments).

An “installment plan” or “installments plan” may be a scheme for dividing something across two or more events based on an installment time. For example, the event may be paying for a portion of a total amount, and the installment time may be a month (e.g., for monthly payments). In some cases, an installment plan may be linked to a new, unique line of credit. In some cases, an installment plan may be linked to a particular payment instrument such as a debit card or credit card. In some cases, the card may be a card issued specifically for installments (an “installments card”). Alternatively, the card may be a user's credit card, for which installments have been temporarily or permanently enabled, along with typical functionalities such as debit or traditional credit payment processing.

A “plan identifier” can include a sequence of characters used to identify or refer to a plan such as an installment plan. A plan identifier can be associated with a particular plan. For example, a first plan identifier can identify and be associated with a first plan, while a second plan identifier can identify and be associated with a second plan. A plan identifier can include alphanumeric characters that may refer to a plan. For example, a plan identifier can be “001” or “plan1,” which may refer to a first plan. As another example, a plan identifier can be “GX834KL” which may refer to plan.

A “resource provider” may be an entity that can provide a resource such as goods, services, information, and/or access. Examples of resource providers includes merchants, data providers, transit agencies, governmental entities, venue and dwelling operators, etc. A “merchant” may typically be an entity that engages in transactions and can sell goods or services, or provide access to goods or services.

A “resource provider computer” may be a computer operated by a resource provider. Suitable computers may include access devices, back end server computers, as well as combinations of the above.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be an example of a “transport computer.”

An “authorizing entity” may be an entity that authorizes a request. Examples of an authorizing entity may be an issuer, a governmental agency, a document repository, an access administrator, etc. An authorizing entity may operate an “authorizing computer” or an “authorizing entity computer.” An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

“Interaction data” may include any suitable information associated with an interaction between an access device and a user device. Interaction data may include any suitable data associated with an interaction (e.g., a purchase transaction.). In some embodiments, interaction data may include any suitable combination of: identification data associated with an access device (e.g., one or more identifiers of an access device), identification information associated with a user device (e.g., one or more identifiers associated with a user device), an interaction value (e.g., a transaction amount such as a preauthorization amount and/or purchase price of a transaction), payment data (e.g., a payment account identifier associated with a payment account), one or more locations each associated with an access device and/or a user device, or any suitable information. Examples of payment data may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment data may be any information that identifies or is associated with a payment account. Payment data may be provided in order to make a payment from a payment account. Payment data can also include a username, an expiration date, a gift card number or code, and any other suitable information. Interaction data may relate to ticket information for an event, data to access a building, transit ticket information, passwords, biometrics or other credentials to access secure data, etc.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

A “virtual account” may be an account associated with a user and is virtual. A virtual account can be a payment account that may be usable for processing a transaction. For example, a virtual account can be an account involving the processing of credit or debit values. In some examples, a virtual account may be a prepaid account, or may be generated for the purposes of storing a prepaid value in preparation of processing future transactions. In some examples, a virtual account can be identified using a virtual account number.

A “cryptogram” may include a piece of obscured text such as encrypted text. A cryptogram may be formed by encrypting input data with an encryption key such as a symmetric encryption key. In some embodiments, a cryptogram is reversible so that the inputs that are used to form the cryptogram can be obtained using the same symmetric key to perform a decryption process. In some embodiments, if input data is encrypted using a private key of a public/private key pair, the cryptogram may also be a digital signature. A digital signature may be verified with a public key of the public/private key pair. In some embodiments, a cryptogram may include a dCVV (dynamic card verification value).

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments of the disclosure include a network computer capable of receiving an authorization request message comprising a token and a cryptogram during an interaction between a resource provider and a user. The network processing computer can determine user credentials associated with the token. The network processing computer can then determine an installment plan identifier based on the authorization request message. The network processing computer can then provide the installment plan identifier to an authorizing entity computer. The authorizing entity computer can then determine whether or not to authorize the interaction. In some embodiments, the installment plan identifier or plan information (e.g., a name, terms and conditions, etc.) can be sent to the authorizing entity computer via a communication separate from the authorization process. For example, the plan identifier or plan information can be sent to the authorizing entity computer via an API. In other embodiments, the plan identifier or plan information associated with the plan identifier is sent to the authorizing entity computer in a modified authorization request message that contains the plan identifier or plan information.

In some embodiments, the authorizing entity computer can set up plans for a user (e.g., installment plans, data plans, etc.). In other embodiments, the authorizing entity computer can set up the plans in conjunction with the network processing computer. The network processing computer can generate and assign a plan identifier of each plan received from the authorizing entity computer. Further, each plan may be associated with plan metadata (e.g., data relating to the plan). Plan metadata may be an example of plan information. The plan metadata can include, for example, the length of the plan, a number of increments of the plan, an amount of each increment (e.g., information about the interest rate or any fees), an expiration date of the plan, a minimum amount of the plan, a location requirement of the plan, etc. The network processing computer can provide the plan identifiers and the plan metadata to a service provider computer. The service provider computer can store the plan identifiers and plan metadata onto the user device and/or at the service provider computer. Then during an interaction and when selecting a particular plan to use for the interaction, the user device can generate a cryptogram (e.g., TAVV (Token Authentication Verification Value)) based on the plan identifier associated with a plan selected by the user. The user device can provide the cryptogram along with a token to the network processing computer via the resource provider computer in an authorization request message. The network processing computer can determine the plan identifier from the cryptogram, which allows the network processing computer to determine which plan the user selected. In some embodiments, this does not expand the size of the authorization request message to include additional data.

In other embodiments, the network processing computer can assign a plan identifier to each plan that the user is eligible for. The network processing computer can provide the plan identifiers to the service provider computer. For example, a user may be associated with (e.g., qualified for) five different plans. The network processing computer can provide the plan identifiers for the five plans to the service provider computer. The network processing computer may also provide plan metadata for each plan to the service provider computer. The service provider computer can then store the plan identifiers and associated metadata onto the user device. During an interaction, after a user selects a plan, the user device can determine the plan identifier associated with a plan selected by a user. The user device can provide the plan identifier to the network processing computer in a cryptogram that will be sent in the authorization request message. The user device can then provide a token associated with user credentials to the resource provider computer, which can generate and provide an authorization request message for the interaction to the network processing computer. The network processing computer can then determine the plan identifier of the plan that the user selected from the cryptogram. As noted above, the plan identifier or plan information associated with the plan identifier may be provided to the authorizing entity computer via an API or via the authorization request message.

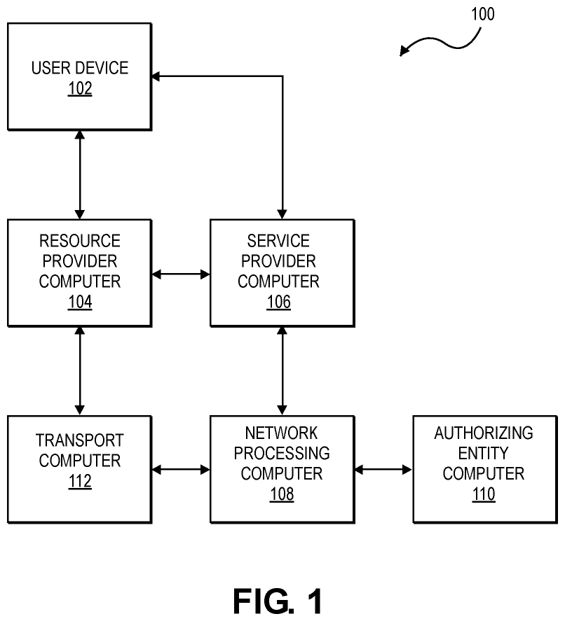

FIG. 1 shows a system 100 according to embodiments of the disclosure. The system 100 comprises a user device 102, a resource provider computer 104, a service provider computer 106, a network processing computer 108, an authorizing entity computer 110, and a transport computer. The user device 102 can be in operative communication with the resource provider computer 104 and the service provider computer 106. The resource provider computer 104 can be in operative communication with the service provider computer 106, the network processing computer 108, and the transport computer 112. The network processing computer 108 can be in operative communication with the service provider computer 106, the authorizing entity computer 110, and the transport computer 112.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between the components in system 100 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can be any suitable device operated by a user. For example, in some embodiments, the user device 102 can be a mobile device. The user device 102 can be configured to receive plan information (e.g., installment plan information) from, for example, the service provider computer 106. The user device 102 can be configured to receive input from the user regarding a selection of a plan. The user device 102 can also be configured to transmit an indication of acceptance of the plan to the network processing computer 108. The user device 102 may further be configured to initiate interactions (e.g., via the service provider computer 106) with the resource provider of the resource provider computer 104.

The service provider computer 106 can receive data from the user device 102, or other suitable device operated by the user, and can perform an interaction, such as a transaction. The service provider computer 106 can also receive data from a network processing computer. The service provider computer 106 may receive information about plan options and display such information to the user. In some embodiments, the service provider computer 106 may facilitate preparing and transmitting messages such as authorization request messages for interactions.

In some embodiments, the service provider computer 106 can be associated with an application stored on the user device 102 (e.g., a service provider application). The service provider application can be configured to perform operations locally on the user device that may be described herein as performed by the service provider computer 106.

The resource provider computer 104 may be associated with a resource providing entity. The resource provider computer 104 may receive, transmit, and analyze messages such as authorization request messages, authorization response messages, and messages about plans. The resource provider computer 104 may generate settlement requests to request funds for resources provided. The resource provider computer 104 may communicate authorization request messages to the transport computer 112 during the interaction.

In some embodiments, the transport computer 112 may be associated with the resource provider computer 104 and may manage authorization requests on behalf of the resource provider computer 104. In some embodiments, the transport computer 112 is operated by an acquirer. The transport computer 112 can manage installment functions for a resource provider (e.g., by interacting with APIs exposed by the network processing computer 108 on behalf of the resource provider computer 104).

The authorizing entity computer 110 may be a system associated with an issuer or entity (e.g., a bank) that has a business relationship with a network processing computer 108 or other entity. The authorizing entity computer 110 may determine whether or not to authorize interactions associated with the interaction. The authorizing entity computer 110 may receive, send, and analyze payment messages such as authorization request messages and authorization response messages.

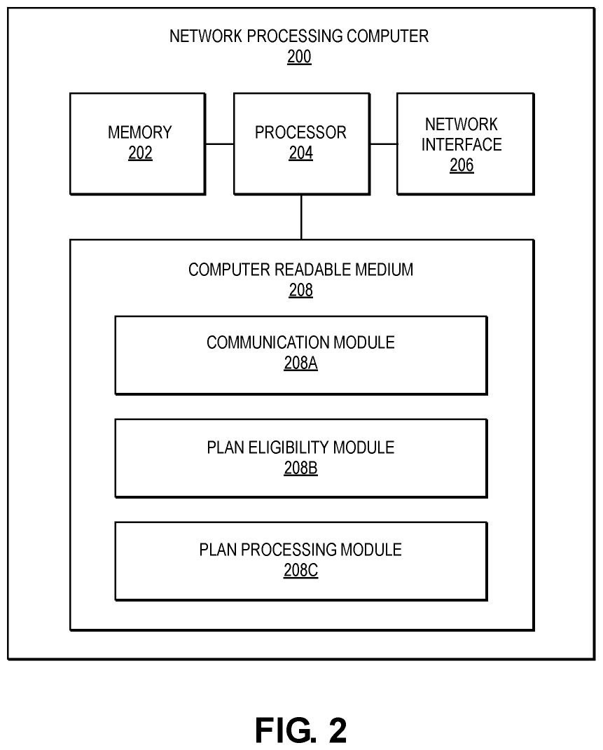

The network processing computer 108 may be disposed between the transport computer 112 and the authorizing entity computer 110. The network processing computer 108 may include data processing subsystems, networks, and operations used to support and deliver authorization services, exception file services, and clearing and settlement services. For example, the network processing computer 108 may comprise a server coupled to a network interface (e.g., by an external communication interface), and databases of information. The network processing computer 108 may be or be part of a transaction processing network. The network processing computer 108 may expose a set of APIs to other entities to provide installments services. The network processing computer 108 may manage access to such APIs (e.g., by managing and issuing keys to entities to control access permissions). The network processing computer 108 may use any suitable wired or wireless network, including the Internet. Components and functionalities of the network processing computer 108 are further described below with respect to FIG. 2.

FIG. 2 shows a block diagram of a network processing computer 200 according to embodiments. The exemplary network processing computer 200 may comprise a processor 204. The processor 204 may be coupled to a memory 202, a network interface 206, and a computer readable medium 208. The computer readable medium 208 can comprise a number of modules including a communication module 208A, a plan eligibility module 208B, and a plan processing module 208C.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. The memory 202 can store any suitable data described herein.

The computer readable medium 208 may comprise code, executable by the processor 204, for performing a method comprising: receiving, by a network processing computer, an authorization request message comprising a token and a cryptogram during an interaction between a resource provider and a user; determining, by the network processing computer, user credentials associated with the token; determining, by the network processing computer, a plan identifier based on the authorization request message; and providing, by the network processing computer, the plan identifier or plan information associated with the plan identifier to an authorizing entity computer.

In some embodiments, the network processing computer 200 can comprise any suitable number of modules. For example, the network processing computer 200 can comprise the communication module 208A that may comprise code that causes the processor 204 to generate messages, forward messages, reformat messages, and/or otherwise communicate with other entities. When an electronic message is received by the network processing computer 200 via the network interface 206, it may be passed to the communication module 208A. The communication module 208A, in conjunction with the processor 204, may identify and parse the relevant data based on a particular messaging protocol used in the system. The communication module 208A, in conjunction with the processor 204, may then transmit any received information to an appropriate module within the network processing computer 200 (e.g., via a data bus line, etc.). The communication module 208A may also receive information from one or more of the modules in the network processing computer 200 and generate an electronic message in an appropriate data format in conformance with a transmission protocol, such that the message may be sent to one or more entities within system 100. The electronic message may then be passed to the network interface 206 for transmission.

The network processing computer 200 can further include the plan eligibility module 208B that may comprise code that causes the processor 204 to determine whether a particular user, account, or transaction is eligible for one or more installment plans. The plan eligibility module 208B may include code configured to, in conjunction with the processor 204, analyze interaction data and/or user data (which may include account data) to make such eligibility determinations. The plan eligibility module 208B, in conjunction with the processor 204, can determine whether or not a user is eligible for one or more plans based on information associated with the user and one or more requisites associated with each plan.

The network processing computer 200 can further include the plan processing module 208C that may comprise code that causes the processor 204 to manage transaction processing across multiple installments. The plan processing module 208C, in conjunction with the processor 204, can determine a current step of a plan and remaining steps of the plan (e.g., current installments and remaining installments). The plan processing module 208C, in conjunction with the processor 204, may manage performance of such plan steps (e.g., settlement of installment payments).

The network processing computer 200 can further include the plan eligibility module 208B that may comprise code that causes the processor 204 to determine whether a particular user, account, or transaction is eligible for one or more installment plans. The plan eligibility module 208B may include code configured to, in conjunction with the processor 204, analyze interaction data and/or user data (which may include account data) to make such eligibility determinations. The plan eligibility module 208B, in conjunction with the processor 204, can determine whether or not a user is eligible for one or more plans based on information associated with the user and one or more requisites associated with each plan.

In some embodiments, the network processing computer 200 may manage and expose a set of APIs. The APIs may include, as an illustration, an onboarding API, an eligibility check API, a convert to installments API, and a scheduler API.

The network interface 206 may include an interface that can allow the network processing computer 200 to communicate with external computers. The network interface 206 may enable the network processing computer 200 to communicate data to and from another device (e.g., an authorizing entity computer, a resource provider computer, a service provider computer, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

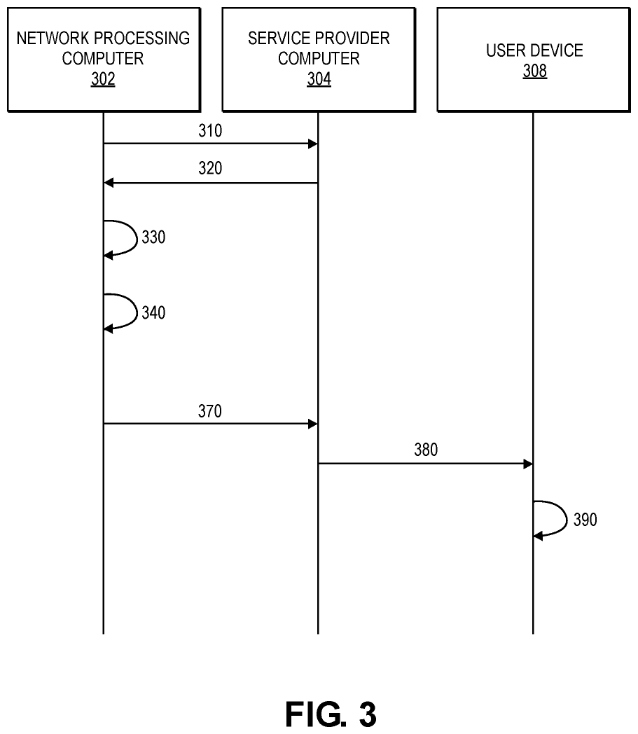

Embodiments can use the systems and apparatuses described herein to at least establish, manage, and or implement installment plans. FIGS. 3-8 describe some examples of such methods.

Although FIG. 2 shows a block diagram of a network processing computer 200, the software functions also alternatively or additionally be present in an authorizing entity computer.

FIG. 3 shows a flow diagram of a pre-interaction setup process according to embodiments. The method illustrated in FIG. 3 will be described in the context of a user device 308 being setup with plan capabilities prior to an interaction. The method of FIG. 3 may be performed by a network processing computer 302, a service provider computer 304, and the user device 308.

Prior to step 310, the network processing computer 302 or an authorizing entity computer (e.g., an issuer computer) (not shown) can determine that a user is eligible for a plan for which the user was previously ineligible. The network processing computer 302 or the authorizing entity computer can determine that the user is eligible in any suitable manner. Further, different plans can have differing eligibility requirements. For example, the network processing computer 302 or the authorizing entity computer can determine that the user is eligible based on the user's interaction history, fraud probability, aggregate scores associated with the user (e.g., credit score, etc.), age, location, affiliation with a resource provider (e.g., a rewards member, account holder, etc.), employer, etc.

At step 310, the network processing computer 302 (or an authorizing entity computer) can notify the service provider computer 304 of a plan eligibility change on an existing token stored by the service provider computer 304. For example, a first user may be associated with a first token stored by the service provider computer 304. Previously, the first user may not be eligible for a particular plan (e.g., an installment plan) that is implemented during an interaction. The network processing computer 302 (or an authorizing entity computer) can notify the service provider computer 304 of the change in eligibility. For example, the network processing computer 302 (or an authorizing entity computer) can provide an eligibility change message comprising an indication of a change in eligibility and data that may be associated with the user (e.g., a user identifier, a user device identifier, a token associated with the user, a PAN reference identifier, etc.).

At step 320, the service provider computer 304, upon receiving the eligibility change notification or at any suitable point in time thereafter, can provide an API call (or other suitable communication type) to the network processing computer 302 (or an authorizing entity computer) to obtain a plan identifier. For example, the service provider computer 304 can generate and provide a plan request message to the network processing computer 302. The service provider computer 304 may further pass the token, PAN reference identifier, or other suitable user identifier to the network processing computer 302, such that the network processing computer 302 can provide the relevant plan identifier.

At step 330, after receiving the plan request message from the service provider computer 304, the network processing computer 302 can obtain a user credential associated with the received token or PAN reference identifier. For example, the network processing computer 302 can obtain the user credential that is associated with the received token by providing the token, in a user credential request message, to a token provider computer. The token provider computer can include a database of stored tokens and associated user credentials. The token provider computer can retrieve the user credential that is associated with a stored token that matches the received token. The token provider computer then provides the user credential to the network processing computer 302.

At step 340, after obtaining the user credential, the network processing computer 302 (or an authorizing entity computer) can obtain eligible plan identifiers that are associated with the user. For example, the network processing computer 302 (or an authorizing entity computer) can retrieve one or more plan identifiers stored in association with the user credentials in a plan database. The network processing computer 302 (or an authorizing entity computer) can obtain any number of eligible plan identifiers from the plan database. For example, the user can be eligible for three different plans. The network processing computer 302 (or an authorizing entity computer) can retrieve the three plan identifiers for the three different plans for which the user is eligible.

In some embodiments, prior to obtaining the eligible plan identifiers, the network processing computer 302, the service provider computer 304, or an authorizing entity computer can perform an eligibility check to check for the user's eligibility for one or more plans. Each plan can have a plan identifier that identifies the plan. For example, a first plan can have a plan identifier of “plan1.” In some embodiments, the plan identifier can be generated by the entity offering the plan (e.g., by an authorizing entity of an authorizing entity computer that is offering a plan to the user of the user device 308). In some embodiments, the plan identifier can be descriptive of the plan. For example, a plan identifier can be “SixMonthPlanABC.”

In some embodiments, a user can be eligible for a plurality of plans. For example, the user can be eligible for three plans. The network processing computer 302 can obtain the eligible plan identifiers for the three plans based on the user credentials.

At step 370, the network processing computer 302 can provide a plan response message to the service provider computer 304. The plan response message can include one or more plan identifiers. In some embodiments, the plan response message can also include the token and/or PAN reference identifier.

The network processing computer 302 can also transmit plan metadata in the plan response message. The plan metadata can include any suitable data associated with the plans available to the user. For example, the plan metadata can include a plan length, a plan amount, a plan expiration date, interest fee information, etc.

At step 380, after receiving the plan response message, the service provider computer 304 can provide the at least the plan identifier to the user device 308. In some embodiments, the service provider computer 304 can provide the plan response message to the user device 308. In some embodiments, the service provider computer 304 can store the plan response message and/or data included therein.

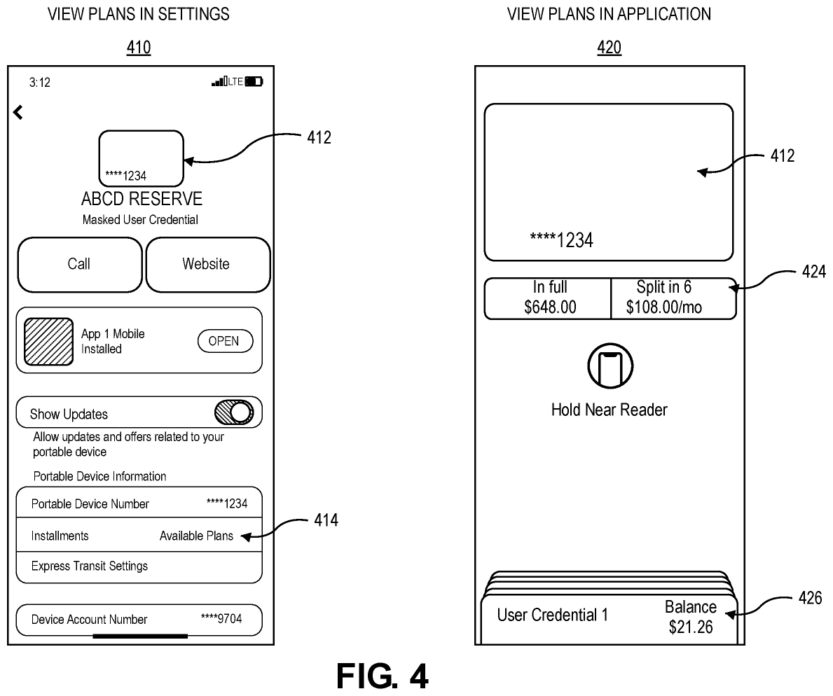

At step 390, the user device 308 can display the data included in the plan response message, for example, as shown in FIG. 4. The user device 308 can display the eligible plans in the user device's application and/or in the user device's settings. During an interaction, the user can select a plan displayed on the user device 308 to utilize for the interaction. In some embodiments, the user device 308 can display a list of plans to the user.

FIG. 4 shows a block diagram of a user plan interface according to embodiments. FIG. 4 illustrates a first user interface 410 and a second user interface 420. The first user interface 410 can allow the user to view plans in the settings of the user device. The second user interface 420 can allow the user to view plans in an application installed on the user device.

The first user interface 410 includes an illustration of the user credential 412 that the user can utilize for an interaction when implementing the plan. For added security, the user credentials can be masked. For example, the masked user credential can be “****1234.” In some embodiments, the first user interface 410 can include a token or PAN reference identifier in addition to, or in lieu of, the user credential 412.

The first user interface 410 can include an available plans button 414. The available plans button 414, when selected by the user, can provide a list of plans that the user is eligible for.

The second user interface 420 includes an illustration of the user credential 422 that the user can utilize for an interaction when implementing the plan. The user credential 422 can be a masked user credential. For example, the masked user credential can be “****1234.”

The second user interface 420 includes plan implementation option 424. The plan implementation option 424 can be a toggle, a button, a link, etc. that allows the user to select to implement a selected plan. For example, the plan implementation option 424 in the second user interface 420 illustrates an installment plan with the option of splitting a payment of $648.00 into payments of $108.00 per month for 6 months.

The second user interface 420 includes a list of masked user credentials that the user can select between. For example, the user can be associated with three different user credentials (e.g., three different payment accounts). The user can select which masked user credential to utilize for the interaction. In some embodiments, when the user selects a user credential, the user credential 422 can be updated to reflect the selected credential.

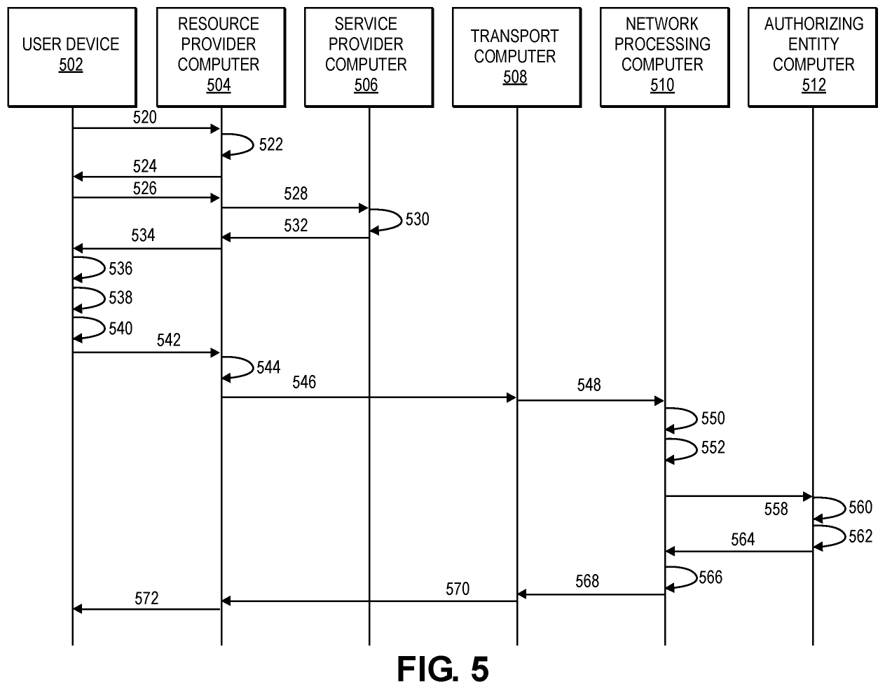

FIG. 5 shows a flow diagram of a plan and interaction processing method according to embodiments. The method of FIG. 5 can be performed by a user device 502, a resource provider computer 504, a service provider computer 506, a transport computer 508, a network processing computer 510, and an authorizing entity computer 512 during an interaction between a user of the user device 502 and a resource provider (e.g., a merchant) of the resource provider computer 504.

At step 520, the user can select to initiate an interaction with a resource provider. For example, the user can initiate a payment transaction with a resource provider of the resource provider computer 504. As an example, the user can select an “add to cart” button on the user device 502, where the “add to cart button” is displayed on a resource provider webpage provided by the resource provider computer 504.

At step 522, after the user selects to initiate an interaction, the resource provider computer 504 can check if utilization of the service provider computer 506 is supported. In some embodiments, the service provider computer 506 can provide a digital wallet to the user device 502. In such a case, the resource provider computer 504 can determine whether or not the digital wallet of the service provider computer 506 is supported for the current interaction. The resource provider computer 504 may check if the user has a card added to the digital wallet. In some embodiments, the resource provider computer 504 may check, with the service provider computer 506, if one or more plans are available to the user.

At step 524, if the resource provider computer 504 determines that the service provider computer 506 is supported in the current interaction, the resource provider computer 504 can then display an option for the user to select whether or not to utilize the service provider computer 506.

In some embodiments, if the resource provider computer 504 received an indication that one or more plans are available from the service provider computer 506, then the resource provider computer 504 can display a plan interaction button. For example, the user may see a message such as “plan available,” “installment payment is available,” etc. The buttons and messages described herein may be presented via any suitable user interface.

At step 526, the user can select to proceed with or without utilization of the service provider computer 506. The user device 502 can provide the selection of whether or not to use the service provider computer 506 to the resource provider computer 504. If the user selects to utilize the service provider computer 506 during the interaction, then the process can proceed to step 528.

At step 528, after receiving the user's selection of the service provider computer 506 utilization option (e.g., a digital wallet button), the resource provider computer 504 can transmit an interaction request message to the relevant service provider computer 506. For example, the user device 502 may provide information regarding the service provider computer 506 along with the selection to utilize the service provider computer 506 to the resource provider computer 504, such that the resource provider computer 504 can determine the service provider computer 506 associated with the user. The interaction request message can request plans that the user is eligible for.

At step 530, after receiving the interaction request message, the service provider computer 506 can check if the user performing the interaction, or the interaction itself, is eligible for one or more plan(s) via stored plan metadata. For example, the service provider computer 506 may have previously received plan metadata for two different plans for which the user is eligible (e.g., as described in FIG. 3). The service provider computer 506 can also store a plan identifier in association with each plan.

At step 532, if the user of the user device 502 is eligible for a plan for the current interaction, then the service provider computer 506 can provide a message comprising at least eligible plan metadata and associated plan identifiers to the resource provider computer 504. In some embodiments, the service provider computer 506 may provide other suitable information to the resource provider computer 504, for example, a token associated with a user credential of the user.

At step 534, after receiving the eligible plan metadata and plan identifiers, the resource provider computer 504 can display an interaction sheet (e.g., on a webpage) including at least available plans to the user on the user device 502. In some embodiments, the interaction sheet may further comprise terms and conditions, interaction data, shipping data, etc. For example, the user device 502 can receive one or more plans from the service provider computer, via the resource provider computer 504, during the interaction.

At step 536, the user may select any suitable button provide on the webpage, for example, a checkout or pay button. The user device 502 can receive the selection of a plan of the one or more plans from the user. For example, the user device 502 can present the list of available plans to the user for selection, then receive an input via a touchscreen indicating a selection of one plan.

In some embodiments, at step 538, the user may be prompted to authenticate themselves. For example, the user may be prompted to verify a passcode, biometric, two factor authentication code or any other suitable information known by or received from the user. The user device 502 can authenticate the user in any suitable manner know to one of skill in the art. In some embodiments, the user may be prompted to authenticate themselves prior to step 536, step 526, step 520, or other suitable step.

At step 540, the user device 502 can generate a cryptogram (e.g., a TAVV) utilizing the plan identifier associated with the selected plan. If no installment plan was selected, then the cryptogram can be generated without the plan identifier associated with the selected plan. In some embodiments, the user device 502 can also generate the cryptogram using the merchant's public key. Alternatively, the cryptogram may be generated using a symmetric key that is generated by or stored within the user device 502.

The cryptogram can also be generated using additional data in addition to the selected plan identifier. For example, the cryptogram can be generated based on a resource provider identifier, an interaction amount, a counter, a time stamp, and/or any other suitable data associated with the interaction. In some embodiments, the cryptogram can be a dynamic, one-time use code for each interaction that accompanies the token. For example, the cryptogram can be a TAVV, which is a 20-byte Base64-encoded binary value.

In some embodiments, step 540 can be performed by a service provider application installed on the user device 502. For example, the service provider application on the user device 502 can generate the cryptogram using the plan identifier associated with the selected plan. In other embodiments, the user device 502 can request the service provider computer 506 to generate the cryptogram and provide the cryptogram to the resource provider computer 504.

At step 542, after generating the cryptogram, the user device 502 can provide the token and the cryptogram to the resource provider computer 504. In some embodiments, if the user device 502 requested the service provider computer 506 to generate the cryptogram, then, at step 542, the service provider computer 506 can provide the token and the cryptogram to the resource provider computer 504.

At step 544, upon receiving the token and the cryptogram, the resource provider computer 504 can generate an authorization request message comprising the token, the cryptogram, and interaction data. The interaction data can be data associated with the interaction. Interaction data can include a transaction amount. In some embodiments, interaction data can indicate different entities that are party to an interaction as well as value or information being exchanged. Interaction data can include an interaction amount, information associated with a sender (e.g., a token or account information, an alias, a device identifier, a contact address, etc.), information associated with a receiver (e.g., a token or account information, an alias, a device identifier, a contact address, etc.), one-time values (e.g., a random value, a nonce, a timestamp, a counter, etc.), and/or any other suitable information. An example of interaction data can be transaction data.

At step 546, after generating the authorization request message, the resource provider computer 504 provides the authorization request message to the transport computer 508.

At step 548, after receiving the authorization request message from the resource provider computer 504, the transport computer 508 provides the authorization request message to the network processing computer 510.

At step 550, after receiving the authorization request message, the network processing computer 510 can de-tokenize the token to obtain a user credential (e.g., a PAN or other suitable credential associated with the user). For example, the network processing computer 510 can obtain the user credential that is associated with the received token by providing a user credential request message comprising the token to a token provider computer (not shown). The token provider computer can include a database of stored tokens and associated user credentials. After receiving the user credential request message, the token provider computer can retrieve the user credential that is associated with a stored token that matches the token. The token provider computer then provides the user credential to the network processing computer 510.

At step 552, after obtaining the user credential, the network processing computer 510 can determine the plan identifier based on the cryptogram. The network processing computer 510 can obtain the plan identifier from the cryptogram since the cryptogram was previously generated using the plan identifier. For example, in some embodiments, the network processing computer 510 can decrypt the cryptogram. The network processing computer 510 can decrypt the cryptogram using asymmetric or symmetric cryptography. For example, the user device 510 can create the cryptogram using a distributed or generated symmetric key. The network processing computer 510 can also store the same symmetric key. Upon receiving the cryptogram, the network processing computer 510 can decrypt the cryptogram using the symmetric key to obtain the data encrypted into the cryptogram by the user device 502. In some embodiments, the user device 510 can determine a derived key (e.g., a session key) based on predetermined data elements (e.g., a user device identifier, a network processing computer public key, etc.) The user device 510 can create the cryptogram using the derived key. Then, once the network processing computer 510 receives the cryptogram, the network processing computer 510 can determine the derived key based on predetermined data elements. The network processing computer 510 can then decrypt the cryptogram using the derived key. In some embodiments, the network processing computer 510 and the user device 510 can create cryptographic keys using a Diffie-Hellman cryptographic process.

In some embodiments, the network processing computer 510 can verify the cryptogram by comparing data obtained when decrypting the cryptogram to previously stored data. For example, a user device identifier can be included, by the user device 502, into the cryptogram. The network processing computer 510 can obtain the user device identifier after decrypting the cryptogram. The network processing computer 510 can compare the user device identifier to a previously stored user device identifier (e.g., stored during enrollment) in a database.

After determining the plan identifier of the plan selected by the user, the network processing computer 510 can provide the plan identifier or plan information (e.g., a plan name, details of the plan, etc.) associated with the plan identifier directly to the authorizing entity computer 512 in a separate communication outside of the authorization process. For example, the plan identifier or plan information may be provided to the authorizing entity computer 512 via an API. The user credential and/or the token may also be passed to the authorizing entity computer 512 via the API to help identifier the user that selected the plan. If the plan identifier and/or the plan information is sent from the network processing computer 510 to the authorizing entity computer 512 outside of the authorization process, then the authorization request message that is sent to the authorizing entity would not have the plan identifier or the plan information.

In some embodiments, the network processing computer 510 can modify the authorization request message. For example, the network processing computer 510 can replace the token in the authorization request message with the user credential. The network processing computer 510 can also insert the plan identifier into the authorization request message if it was not sent to the authorizing entity computer 512 outside of the authorization process. The modified authorization request message can then include the user credential, the cryptogram, the plan identifier, and the interaction data. In some embodiments, network processing computer 510 can also insert the cryptogram verification results into the authorization request message.

At step 558, after modifying the authorization request message, the network processing computer 510 can provide the modified authorization request message to the authorizing entity computer 512. In some embodiments, the network processing computer 510, as noted above, in addition to the modified authorization request message or in lieu of including the plan identifier into the authorization request message, can send the plan identifier or plan information associated with the plan identifier to the authorizing entity computer 512 via an API call (e.g., a plan acceptance API) or via other suitable communication types.

At step 560, after receiving the authorization request message, the authorizing entity computer 512 can determine whether or not to authorize the interaction. At some time, the authorizing entity computer 512 can also implement the plan associated with the plan identifier and/or plan information. The authorizing entity computer 512 can determine whether or not to authorize the interaction based on any suitable data known to the authorizing entity computer 512 (e.g., the interaction data, fraud data, user data, etc.). The authorizing entity computer 512 can generate an indication of whether or not the interaction is authorized. For example, if the authorizing entity computer 512 determines to authorize the interaction, then the authorizing entity computer 512 can generate an indication that the interaction is authorized. If the authorizing entity computer 512 determines not to authorize the interaction, then the authorizing entity computer 512 can generate an indication that the interaction is not authorized. The authorizing entity computer 512 can also generate an indication of whether or not the selected plan was authorized.

At step 562, after determining whether or not to authorize the interaction, the authorizing entity computer 512 can generate an authorization response message in response to the authorization request message. The authorization response message can comprise the indication of whether or not the interaction is authorized. The authorization response message can also include the user credential and the plan identifier. In some embodiments, the authorization response message can include the indication of whether or not the selected plan was authorized.

At step 564, the authorizing entity computer 512 can provide the authorization response message to the network processing computer 510.

At step 566, after receiving the authorization response message from the authorizing entity computer 512, the network processing computer 510 can modify the authorization response message to include the token. For example, the network processing computer 510 can replace the user credential in the authorization response message with the token. In some embodiments, the network processing computer 510 can obtain the token from the token provider computer. For example, the network processing computer 510 can provide a token request message comprising the user credential to the token provider computer. Upon receiving the token request message, the token provider computer can determine the token associated with the user credential (e.g., in a token and user credential database). The token provider computer can provide a token response message comprising the token to the network processing computer 510. The network processing computer 510 can then modify the authorization response message to include the token.

At step 568, after including the token into the authorization response message, the network processing computer 510 can provide the authorization response message to the transport computer 508.

At step 570, after receiving the authorization response message from the network processing computer 510, the transport computer 508 can provide the authorization response message to the resource provider computer 504.

At step 572, after receiving the authorization response message the resource provider computer 504 can provide the authorization response message to the user device 502. For example, the resource provider computer 504 can provide a webpage indicating whether or not the interaction and the plan were authorized to the user device 502.

At the end of the day or at any other suitable period of time, a clearing and settlement process may take place between the transport computer 508, the network processing computer 510, and the authorizing entity computer 512.

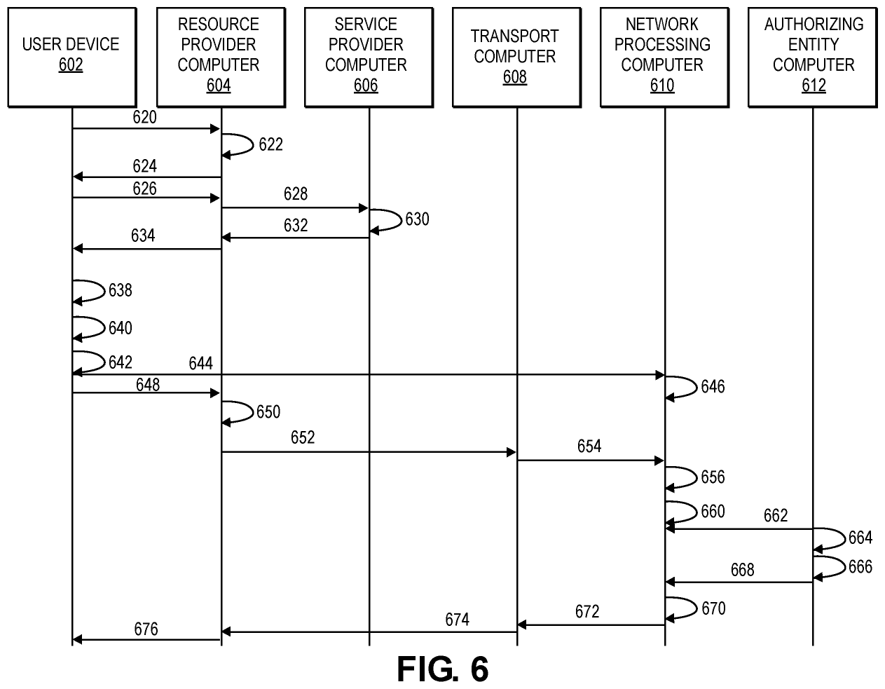

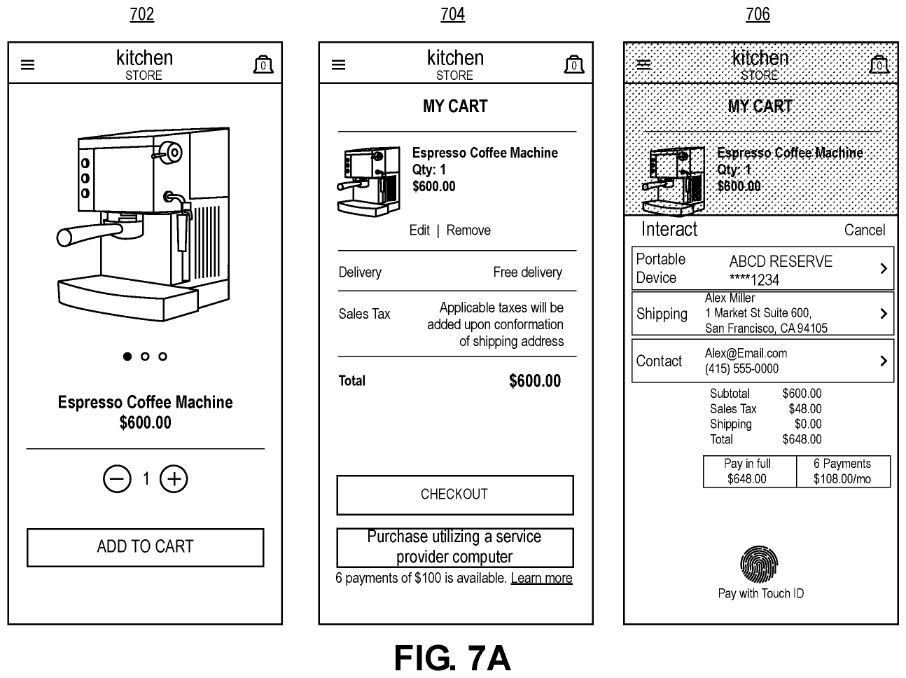

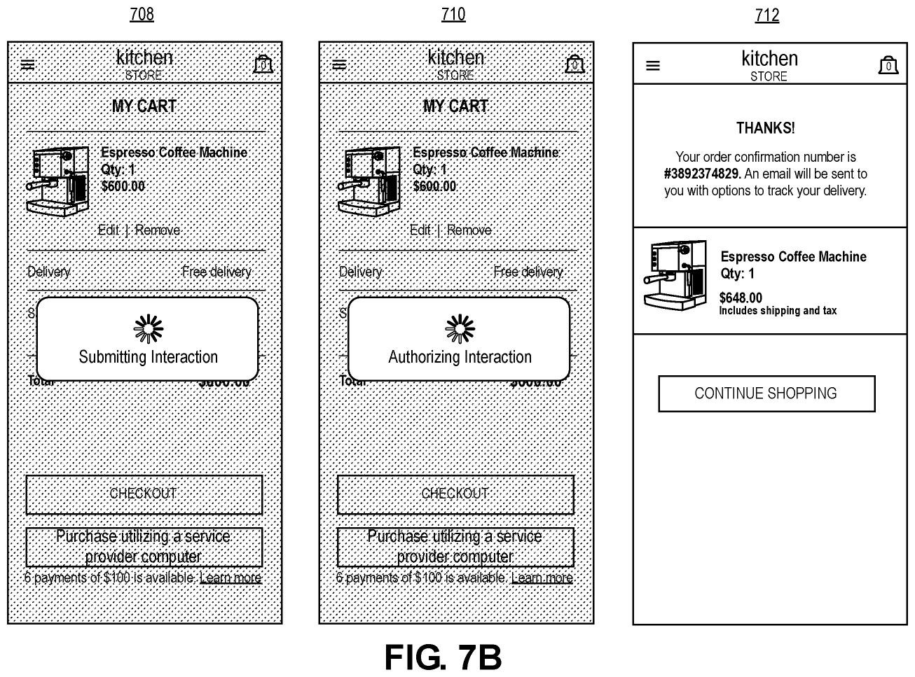

FIG. 6 shows a flow diagram of an alternate plan and interaction processing method according to embodiments. The method of FIG. 6 may be performed by a user device 602, a resource provider computer 604, a service provider computer 606, a transport computer 608, a network processing computer 610, and an authorizing entity computer 612 during an interaction between a user of the user device 602 and a resource provider of the resource provider computer 604. In some embodiments, the steps performed by the service provider computer 606 may be performed by a service provider application stored on the user device 602. FIGS. 7A-7B show block diagrams of a user interface during interaction processing according to embodiments. The user interfaces illustrated in FIGS. 7A-7B will be described in reference to the method of FIG. 6.

Steps 620-638 can be similar to steps 520-538 and will not be repeated here in their entirety. For example, during steps 620-638, a user of the user device 602 can initiate an interaction with a resource provider computer 604 to obtain a resource. The user can utilize the user device 602 to select an interaction option presented on a webpage provided by the resource provider computer 604. For example, the first user interface 702 and the second user interface 704 of FIG. 7A include interaction options (e.g., buttons) on resource provider hosted webpages. The webpage illustrated in the first user interface 702 can be a resource (e.g., expresso coffee machine) webpage. The webpage illustrated in the second user interface 704 can be a “cart” webpage that can indicate what resources have been selected (e.g., an expresso coffee machine) to the user. The user can select to add the resource to the cart on the first user interface 702, then select to perform the interaction on the second user interface 704. Additionally, the second user interface 704 can allow the user to choose between different interaction options. For example, the second user interface 704 includes a “checkout” option and a “purchase utilizing a service provider computer” option, which allow the user to perform an interaction and perform an interaction utilizing a service provider computer, respectively.

Referring back to FIG. 6, the resource provider computer 604 can receive an indication that the user has selected to perform the interaction (e.g., the user can select to “purchase utilizing a service provider computer”). The resource provider computer 604 can transmit an interaction request message to the relevant service provider computer 606.

At step 632, the service provider computer 606 can respond to the resource provider computer 604 with an interaction response message including plan identifiers and plan metadata. The interaction response message may include any suitable information regarding the interaction as well as plans available to the user. For example, in some embodiments, the interaction response message can include purchase line items and total, billing and shipping information, contact information, installment information, etc.

At step 634, after receiving the interaction response message, the resource provider computer 604 can display plans and/or interaction data (e.g., an interaction sheet) to the user via the webpage displayed on the user device 602. For example, the resource provider computer 604 can transmit the plan metadata, the plan identifiers, the interaction data, and/or other data related to the interaction and/or received from the service provider computer 606 to the user device 602. The interaction sheet can include any of the data included in the payload received from the service provider computer 606. The user can, for example, review the interaction sheet. Further, the user may select to proceed with the interaction based on the received interaction sheet. For example, if the plans are installment plans, then the user may select an installment plan of the list of installment plans. As an illustrative example, the third user interface 706 of FIG. 7A includes the resource provider webpage presenting an available plan and interaction data.

In some embodiments, at step 638, the user may be prompted to authenticate themselves, similar to step 538 of FIG. 5. For example, the user may be prompted to verify a passcode, biometric, two factor authentication code or any other suitable information known by or received from the user.

At step 640, after receiving a selection of a plan from the user, the user device 602 can determine the plan identifier based on the selected plan. For example, each plan presented on the resource provider webpage can be associated with a plan identifier. Upon selection of the plan to utilize during the interaction, the user device 602 can obtain the plan identifier for the selected plan.

At step 642, after determining the plan identifier, the user device 602 can obtain a token. The token can be associated with a user credential of the user. The token can be stored by the service provider computer 606. In some embodiments, the user device 602 can request the token from the service provider computer 606. In other embodiments, a service provider application associated with the service provider computer 606 can be installed on the user device 602. The service provider application can securely store the token. The user device 602 can obtain the token from the service provider application.

At step 644, after determining the plan identifier and obtaining the token, the user device 602 can provide the plan identifier and the token to the network processing computer 610. In some embodiments, the user device 602 can further include the interaction data and/or other data related to the interaction, the resource provider computer 604 (e.g., a resource provider computer identifier), the service provider computer 606 (e.g., a service provider computer identifier), etc.

At step 646, after receiving the plan identifier and the token, the network processing computer 610 can store the plan identifier in association with the token temporarily for the current interaction. The network processing computer 610 can store the selected plan identifier in association with the user (e.g., via a user identifier or the token) and/or any other suitable data associated with the interaction (e.g., interaction data).

At step 648, after determining the plan identifier and obtaining the token, the user device 602 can provide the token to the resource provider computer 604. In some embodiments, the service provider computer 606 can perform step 646 before, after, or concurrently with step 644. In some embodiments, the user device 602 can further generate a cryptogram for the interaction, as described herein. The cryptogram may or may not be generated based on the plan identifier. The user device 602 can provide the cryptogram to the resource provider computer 604 along with the token. A fourth user interface 708 of FIG. 7B includes a notification to the user that indicates that the resource provider computer 604 has processing the interaction and preparing to submit an authorization request message to the authorizing entity computer 612. For example, the fourth user interface 708 includes a loading icon and a notification of “submitting interaction.”

At step 650, after receiving at least the token, the resource provider computer 604 can generate an authorization request message comprising the token. The authorization request message can further include the interaction data and/or the cryptogram.

At step 652, after generating the authorization request message, the resource provider computer 604 can transmit the authorization request message to the transport computer 608. A fifth user interface 710 of FIG. 7B includes a notification to the user that indicates that the resource provider computer 604 has submitted the authorization request message to the authorizing entity computer 612. For example, the fifth user interface 710 includes a loading icon and a notification of “authorizing interaction.”

At step 654, after receiving the authorization request message from the resource provider computer 604, the transport computer 608 can provide the authorization request message to the network processing computer 610.

At step 656, after receiving the authorization request message, the network processing computer 610 can obtain a user credential associated with the token. For example, the network processing computer 610 can detokenize the token to determine the user credential (e.g., a PAN). In some embodiments, the network processing computer 610 can detokenize the token in conjunction with a token provider computer (not shown) as described in further detail herein.

In some embodiments, the network processing computer 610 may have previously determined the plan identifier during step 646 and stored the plan identifier in association with user and/or user device 602 identifying data (e.g., a user identifier, a user device identifier, the token, etc.). In such a case, at step 658, the network processing computer 610 can retrieve the plan identifier from memory (or a database).

At step 660, after obtaining the plan identifier of the selected plan, the network processing computer 610 can modify the authorization request message to comprise the user credential and the plan identifier or plan information associated with the plan identifier, as described above. Or, the plan identifier and/or plan information associated with the plan identifier can be sent to the authorizing entity computer outside of the authorization process (e.g., via an API).

At step 662, the network processing computer 610 can transmit the modified authorization request message to the authorizing entity computer 612 for authorization. The network processing computer 610 can provide the modified authorization request message to the authorizing entity computer 612 over any suitable communication channel.

Steps 664-676 are similar to steps 560-572 and will not be repeated here in their entirety. At step 676, after the resource provider computer 604 receives the authorization response message from the network processing computer 610 via the transport computer 608, the resource provider computer 604 can provide an indication of whether or not the interaction is authorized to the user via the webpage accessed and displayed by the user device 602. For example, the sixth user interface 712 of FIG. 7B includes a webpage that indicates that the interaction is authorized.

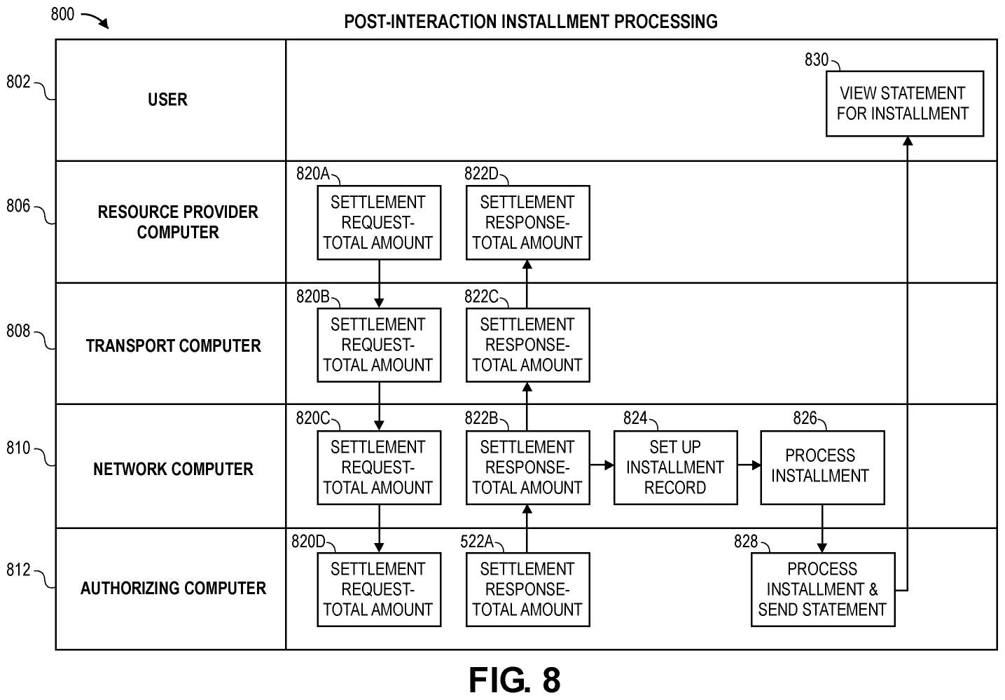

FIG. 8 illustrates a schematic diagram of techniques 800 for post-interaction installment processing according to some embodiments. A network computer 810 (substantially similar to the network processing computer 108 of FIG. 1) may manage installment plan processing for entities such as a user 802 (e.g., via user device 102 of FIG. 1), a resource provider computer 806 (substantially similar to the resource provider computer 104 of FIG. 1), a transport computer 808, and an authorizing computer 812 (substantially similar to the authorizing entity computer 110 of FIG. 1).

At step 820A, the resource provider computer 806 may transmit, to the transport computer 808, a settlement request message. The settlement request message may request funding for the total amount of an interaction. The settlement request message may further include additional data such as interaction data (e.g., timestamp, transaction identifier, etc.) and/or an installment plan identifier. At step 820B, the transport computer 808 may transmit the settlement request message to the network computer 810.

The transport computer 808 may receive the settlement request message and analyze data therein (e.g., installment plan identifier). The transport computer 808 may identify that an installment plan is associated with the settlement request. At step 820C, the transport computer 808 may transmit the settlement request message to the authorizing computer 812, which is received by the authorizing computer at step 820D.

Responsive to receiving the settlement request message, the authorizing computer 812 may analyze the settlement request message and determine to proceed with settlement. At step 822A, the authorizing computer 812 may transmit a settlement response message, for the total amount, to the network computer. At step 822B, the network computer 810 may transmit the settlement response message to the transport computer 808. At step 822C, the transport computer 808 may transmit the settlement response message to the resource provider computer 806. At step 822D, the resource provider computer 806 may receive the settlement response message. Settlement may be completed for the full amount. For example, if the user 802 purchased a resource (e.g., a television) that cost $699.00, then the authorizing computer 812 can settle with the network computer 810 and the transport computer 808 for the same cost, $699.00.

At step 824, the network computer 810 (or the authorizing computer 812) may set up an installment record. In some embodiments, the installment record may be a temporary account. The temporary account may be a virtual account (e.g., the virtual account may exist as a ledger for record keeping purposes). Alternatively, or additionally, the temporary account may be a prepaid account (e.g., the prepaid account may be loaded with funds and limited to the funds loaded). The installment record may be stored to the network computer 810 in association with the installment plan identifier and associated interaction data. For example, the network computer may create a temporary account for the installment plan and an identifier for the temporary account for the installment plan. The network computer may record information including the total amount for the installment plan/interaction to the temporary account associated with the account identifier. Thus, the installment record may be a temporary account with a starting balance of the total amount.

At step 826, the network computer 810 may process an installment. This may occur periodically subject to some condition (e.g., receiving an API call from the authorizing computer and/or determining that an installment time has occurred). In some embodiments, occurrence of an installment time may be when a particular time has elapsed since the last installment and/or since the interaction (e.g., for monthly installments, the network computer 810 may determine that the installment time has occurred when one month has elapsed since the day the transaction was authorized). In some embodiments, the installment time may be computed based on the installment period (e.g., begin processing monthly installment after two weeks to account for messaging and fund transfer times).

At step 828, the authorizing computer 812 may process the installment and send a statement to the user 802. For example, based on information received from the network computer 810, the authorizing computer 812 may determine that the user 802 should be charged the full amount of the transaction, but billed an installment amount of $133 on the statement. The authorizing computer 812 may prepare a statement with the installment amount and send it to the user 802. The user may receive and view the statement for the installment at step 830.

Embodiments of the disclosure have a number of advantages. For example, embodiments provide for an efficient manner of indicate to a network processing computer that a current interaction is an interaction that will utilize a plan as well as details regarding the plan. Currently, interactions between a resource provider and a user include various messages of standard length. Embodiments provide for a method in which additional information, such as the plan identifier can be provided to from a resource provider computer to a network processing computer, without expanding the length of the messages or adding additional messages between entities. This is due to the cryptogram being generated using the plan identifier of the selected plan.

Furthermore, during a typical interaction, if a plan is to be selected and implemented, user is notified of available plans after the resource provider computer submits interaction data for authorization. For example, the network processing computer receives the authorization request message including the interaction data for authorization of the interaction from the resource provider computer. The network processing computer can then reach out to the user to query the user on whether or not the user wants to select a plan, thus slowing down the processing of the interaction due to messaging and waiting for user input. Embodiments provide for fewer messages being sent during processing of the authorization request message, thus reducing the time taken to authorize the interaction.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a network processing computer, an authorization request message comprising a token and a cryptogram during an interaction between a resource provider and a user;
determining, by the network processing computer, user credentials associated with the token;
determining, by the network processing computer, a plan identifier based on the authorization request message; and
providing, by the network processing computer, the plan identifier or plan information associated with the plan identifier to an authorizing entity computer.

2. The method of claim 1 further comprising:
receiving and storing the plan identifier in a database, wherein determining comprising retrieving the plan identifier from the database.

3. The method of claim 1, wherein a user device associated with the user generates the cryptogram based on the plan identifier, and wherein determining the play identifier comprises decrypting the cryptogram to obtain the plan identifier.

4. The method of claim 3, wherein the user device provides the cryptogram and the token to a resource provider computer associated with the resource provider, and wherein the resource provider computer provides the authorization request message to the network processing computer.

5. The method of claim 1, wherein providing, by the network processing computer, the plan identifier to an authorizing entity computer, comprises providing the plan identifier to the authorizing entity computer in a modified authorization request message that is sent to the authorizing entity computer.

6. The method of claim 1, wherein providing, by the network processing computer, the plan identifier to an authorizing entity computer, comprises providing the plan identifier to the authorizing entity computer via an API.

7. The method of claim 1, wherein determining the user credentials associated with the token comprises:
providing, by the network processing computer, the token to a token provider computer, wherein the token provider computer determines the user credentials associated with the token; and
receiving, by the network processing computer, the user credentials from the token provider computer.

8. The method of claim 1 further comprising:
receiving, by the network processing computer, an authorization response message from the authorizing entity computer, wherein the authorization response message comprises an indication of whether or not the interaction is authorized.

9. The method of claim 8 further comprising:
providing, by the network processing computer, the user credentials to a token provider computer, wherein the token provider computer determines the token associated with the user credentials;
receiving, by the network processing computer, the token from the token provider computer;
modifying, by the network processing computer, the authorization response message to comprise at least the indication of whether or not the interaction is authorized and the token; and
providing, by the network processing computer, the authorization response message to a resource provider computer associated with the resource provider.

10. The method of claim 1, wherein the authorization request message is received from a resource provider computer associated with the resource provider, and wherein prior to receiving the authorization request message, a user device associated with the user receives one or more plans from a service provider computer during the interaction, receives a selection of a plan of the one or more plans from the user, determines a plan identifier based on the selected plan, obtains the token, and provides the plan identifier and the token to the resource provider computer, wherein the resource provider computer generates the authorization request message comprising the token and provides the authorization request message to the network processing computer.

11. A network processing computer comprising:
a processor; and
a computer readable medium coupled to the processor, the computer readable medium comprising code, executable by the processor, for implementing a method comprising:
receiving an authorization request message comprising a token and a cryptogram during an interaction between a resource provider and a user;
determining user credentials associated with the token;
determining a plan identifier based on the authorization request message; and
providing the plan identifier or plan information associated with the plan identifier to an authorizing entity computer.

12. The network processing computer of claim 11, further comprising a network interface coupled to the processor.

13. The network processing computer of claim 12, wherein a user device associated with the user generates the cryptogram based on the plan identifier.

14. The network processing computer of claim 13, wherein the user device provides the cryptogram and the token to a resource provider computer associated with the resource provider, and wherein the resource provider computer provides the authorization request message to the network processing computer.

15. The network processing computer of claim 11, wherein the method further comprises storing the plan identifier along with the token in a database.

16. The network processing computer of claim 11 further comprising, on the computer readable medium:
a communication module; and
a plan processing module.

17. The network processing computer of claim 11, wherein the user credentials comprise a PAN.

18. A method comprising:
receiving, by a user device, one or more plans from a service provider computer during an interaction between a user of the user device and a resource provider of a resource provider computer;
receiving, by the user device, a selection of a plan of the one or more plans from the user;
determining, by the user device, a plan identifier based on the selected plan;
obtaining, by the user device, a token; and
providing, by the user device, the plan identifier and the token to the resource provider computer.

19. The method of claim 18, wherein providing the plan identifier to the resource provider computer comprises providing the plan identifier in encoded form in a cryptogram.

20. The method of claim 19, wherein the method further comprises:
generating the cryptogram.
